(19) United States
(12) Patent Application Publication
(10) Pub. No.: US 2007/0193869 A1
(43) Pub. Date: Aug. 23, 2007

(54) KEY SWITCH DEVICE

(76) Inventor: Tomio Sato, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/617,175

(22) Filed: Dec. 28, 2006

(30) Foreign Application Priority Data
Feb. 21, 2006 (JP) P2006-044233

(51) Int. Cl. H01H 13/70

(52) U.S. Cl. 200/344

(57) ABSTRACT

A first bearing member is provided on a key top. A second bearing member is provided on the key top. A first guide member is provided on a board. A second guide member is provided on the board. A first link member is disposed between the board and the key top, and has a first end portion rotatably supported by the first bearing member and a second end portion engaged with the first guide member. A second link member is disposed between the board and the key top, and has a third end portion rotatably supported by the second bearing member and a fourth end portion engaged with the second guide member. A third link member is disposed between the board and the key top. The first link member, the second link member, and the third link member are not in contact with each other. The second end portion is slidable relative to the first guide member in a first horizontal direction so that the first end portion is movable in a vertical direction. The fourth end portion is slidable relative to the second guide member in a second horizontal direction opposite to the first horizontal direction so that the third end portion is movable in the vertical direction. The first link member and the second link member are symmetrically arranged.

The disclosure of Japanese Patent Application No. 2006-044233 filed Feb. 21, 2006 including specification, drawings and claims is incorporated herein by reference in its entirety.

### BACKGROUND

The present invention relates to a key switch device. More particularly, the present invention relates to a link-type key switch device suitably used for a slim keyboard of a notebook PC.

A related-art link-type key switch device is disclosed in Japanese Patent Publication No. 2001-283675A. As shown in FIG. 5, the related-art key switch device includes a board 1, a key top 2, a rubber spring 3 interposed between a board 1 and the key top 2, and a small link member 4 and a large link member 5 interposed between the board 1 and the key top 2. The rubber spring 3, the small link member 4, and the large link member 5 hold the key top 2 to allow the key top 2 to be movable up and down.

More specifically, the small link member 4 is made of a synthetic resin material. A lower end portion of the small link member is mounted on a slide guide (not shown) provided on the top surface of the board 1 so as to be slidably in a horizontal direction. An top shaft portion 7 is mounted on a bearing portion 8 provided on the rear surface of the key top 2 so as to be pivotable in a vertical direction. On the other hand, the large link member 5 is formed into a U-shape by bending a wire. An upper end portion of the large link member is mounted in a bearing portion 9 formed in the rear surface of the key top 2 so as to be pivotable in the vertical direction, and a lower end portion of the large link member is mounted in a bearing portion 10 formed on the top surface of the board 1 and the rear surface of the key top 2 so as to be pivotable in the vertical direction.

The key top 2 is held by a lifting mechanism including the small link member 4 and the large link member 5 and the rubber spring 3 so as to be movable up and down, thereby stably moving in a vertical stroke.

However, in a link mechanism of the related-art key switch device described above, the upper end portion of the large link member 5 is connected to the bearing portion 9 of a key top 2 so as to be pivotable in the vertical direction. And the lower end portion of the large link member 5 is connected to the bearing portion 10 of a board 1 so as to be pivotable in the vertical direction. With this structure, since the large link member 5 pivots about the bearing portion 10 of the board 1 in the vertical direction, the large link member 5 does not move directly downwards, but it moves in a horizontal direction by an interval D when the key top 2 is depressed. Accordingly, since at least the interval D must be secured as a gap between the key tops, a loss occurs when a plurality of key tops is arranged.

Furthermore, in the related-art key switch device, since only one small link member 4 is provided on one side of the key top 2, a wobbling in a sliding direction and a wobbling in a rotation direction of the key top 2 are easy to occur. Therefore, the wobbling deteriorates the touch of a key. In addition, in the related-art key switch device, the holding force of the key top decreases and the key top may be easily removed.

### SUMMARY

It is therefore an object of the invention to provide a key switch device where the key top can smoothly move directly downward, the wobbling of the key top can be removed, and the holding force of the key top can be increased when the key top is depressed.

In order to achieve the above described object, according to the invention, there is provided a key switch device, comprising:

a board;

a key top;

a first bearing member provided on the key top;

a second bearing member provided on the key top;

a first guide member provided on the board;

a second guide member provided on the board;

a first link member disposed between the board and the key top, and having a first end portion rotatably supported by the first bearing member and a second end portion engaged with the first guide member;

a second link member disposed between the board and the key top, and having a third end portion rotatably supported by the second bearing member and a fourth end portion engaged with the second guide member; and

a third link member disposed between the board and the key top, wherein:

the first link member, the second link member, and the third link member are not in contact with each other;

the second end portion is slidable relative to the first guide member in a first horizontal direction so that the first end portion is movable in a vertical direction;

the fourth end portion is slidable relative to the second guide member in a second horizontal direction opposite to the first horizontal direction so that the third end portion is movable in the vertical direction; and

the first link member and the second link member are symmetrically arranged.

With this configuration, when the key top is depressed, the first and the third end portions rotate in the first and the second bearing members. Simultaneously, the second and the fourth end portions slide relative to the first and the second guide members along a top surface of the board in the first and the second horizontal directions. Therefore, the key top is held by the first and the second link members while receiving an equal force from both sides of the key top. Then, the first and the second link members move so as to allow the key top to move directly downwards. On the other hand, when the depressing force is released, the key top moves directly upwards.

Since the first and the second link members are disposed symmetrically, it is possible to prevent the wobbling in the sliding direction and the wobbling in the rotation direction of the key top. In addition, the key top is held by a pair of the small link members, thereby increasing a force holding the key top.

Since a depressed key top moves directly downward, it is possible to increase a density by narrowing the gap between adjacent key tops. Therefore, it is possible to miniaturize the entirety of a keyboard. In addition, since it is possible to increase the key top's own surface area as large as the gap even in the space of a same keyboard. Therefore, it is possible to improve operability by an operator by increasing the key top's own surface area.

Since it is possible to prevent the wobbling in the sliding direction and the rotation direction of the key top by using the first and the second link members and to perform a depressing operation of the key top smoothly, the touch of the key is improved and a high-quality operation feeling can be obtained.

Since the key top is held from both left and right sides by the first and the second link members, a force holding the key top may be increased.

The second end portion may be slidable in a direction opposite to the second link member in accordance with a movement of the key top member; and

The fourth end portion may be slidable in a direction opposite to the first link member in accordance with the movement of the key top member.

With this configuration, when the key top is depressed, since the second and the fourth end portions of the first and the second link members slide opposite to each other, respectively, and the key top moves directly downwards by the movements of the first and the second link members, it is possible to obtain an effect that the key top can move more smoothly in the vertical direction.

The key switch device may further comprise:

a third bearing member provided on the board; and

a third guide member provided on the key top, wherein:

the third link member has a fifth end portion rotatably supported by the third bearing member and a sixth end portion engaged with the third guide member; and

the sixth end portion is slidable relative to the third guide member in a third horizontal direction perpendicular to the first horizontal direction and the second horizontal direction so that the fifth end portion is movable in the vertical direction.

With this configuration, when the key top is depressed, the fifth end portion rotates in the third bearing member and the sixth end portion slides relative to the guide portion along the top surface of the board, and the key top moves directly downwards. Accordingly, the depressed key top can move directly downwards with a guide by the first and the second link members and a guide by the third link member. In addition, it is possible to prevent the wobbling in the sliding direction and the wobbling in the rotation direction of the key top by the first and the second link members and the third link member and to increase the force holding the key top.

The third bearing member may be formed with a hole rotatably supporting the fifth end portion and a slit communicating with the hole so that the fifth end portion is press-fitted into the hole through the slit.

With this configuration, when a part of the third link member (fifth end portion) is strongly depressed to the slit, the part thereof is press-fitted into the hole of third bearing portion on the board, thereby connecting the third link member with the board.

Since it is possible to easily connect the third link member with the third bearing portion of the board, workability is improved at the time of assembling.

The key switch device may further comprise:

a first rib member supporting the third link member in the first horizontal direction; and

a second rib member supporting the third link member in the second horizontal direction, wherein:

the first rib member and the second rib member clamp the third link member.

With this configuration, since the third link member is stably supported by the first rib and the second rib, the wobbling of the key top may be removed.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1A is a schematic side view showing a key switch device according to an embodiment of the present invention;

FIG. 1B is a schematic perspective view showing a small link member and a large link member according to the embodiment;

FIG. 2 is a section view of the key switch device according to the embodiment;

FIG. 3A is a section view of the key switch device taken along the line A-A shown in FIG. 2, showing a state where a key top is not depressed;

FIG. 3B is a section view of the key switch device taken along the line A-A shown in FIG. 2, showing a state where the key top is depressed;

FIG. 4A is a section view of the key switch device taken along the line B-B shown in FIG. 2, showing a state where the key top is not depressed;

FIG. 4B is a section view of the key switch device taken along the line B-B shown in FIG. 2, showing a state where the key top is depressed; and

FIG. 5 is a section view of a related-art key switch device.

### DETAILED DESCRIPTION OF THE EMBODIMENTS

Hereinafter, an embodiment of a key switch device according to the invention will be discussed with reference to the accompanying drawings.

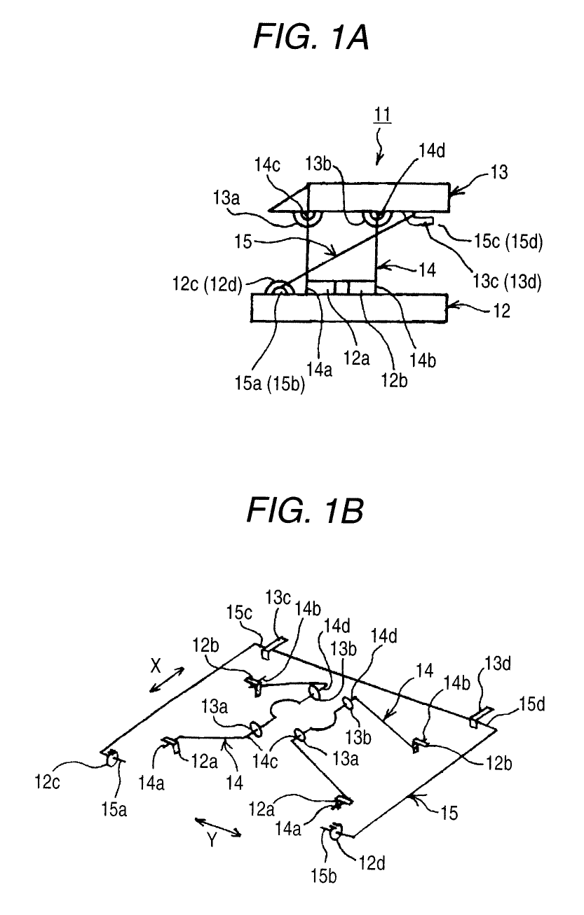

As shown in FIGS. 1A and 1B the key switch device 11 includes a board 12 and a key top 13 provided on the upper side of the board 12. A pair of symmetric small link members 14 and a large link member 15 disposed orthogonal to a pair of the small link members 14 on the outer side of a pair of the symmetrical small link members 14 are interposed between the board 12 and the key top 13 without contact with each other.

The small link members 14 have symmetrical shapes with each other, and are disposed in a symmetric pattern. As shown in FIG. 1B, the small link member 14 integrally includes slide portions 14a and 14b extending in an X direction as both lower end portions. The slide portions 14a and 14b are engaged with slide guides 12a and 12b of the board 12 to slide horizontally (Y direction indicated by an arrow shown in FIG. 1B) on the top surface of the board 12. Meanwhile, top surface of the small link member 14 includes rotary portions 14c and 14d in symmetric opposite portions the rotary portions 14c and 14d are supported by bearing portions 13a and 13b with slits provided in the rear surface of a key top 13 so as to be pivotable in vertical direction.

Meanwhile, as shown in FIG. 1B, the large link member 15 includes rotary portions 15a and 15b extending in a Y direction in both side portions of the lower end portions together. The rotary portions 15a and 15b are supported by bearing portions 12c and 12d with slits provided on the board 12 so as to be pivotable in vertical direction. Meanwhile, the upper end portion of the large link member 15 includes the slide portions 15c and 15d extending in the Y direction in both side portions of the upper end portion. In addition, the slide portions 15c and 15d are slidable horizontally (X direction indicated by an arrow shown in FIG. 1B) on the top surface of the board 12 and are engaged with slide guide 13c and 13d disposed in the rear surface of the key top 13.

Meanwhile, the rotary portions 15a and 15b of the large link member 15 are depressed to slits provided on the peripheral surfaces of the bearing portions 12c and 12d with slits. Then, the slits are temporarily expanded outwardly and the rotary portions 15a and 15b are press-fitted in holes of the bearing portions 12c and 12d with slits. In this mounting structure, the bearing portions 12c and 12d with slits on the board 12 are easily connected to the large link member 15, thereby improving workability at the time of assembling.

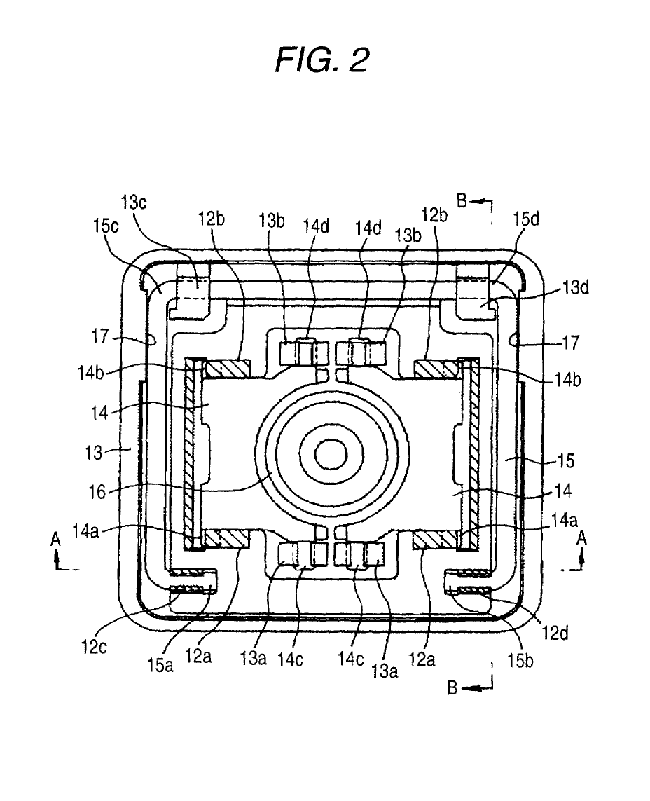

As shown in FIG. 2, in the center portion of the key switch device 11, a substantially dome-shaped rubber spring 16 is placed on a board 12. Ribs 17 and 17 protruding inwardly are provided on both left and right sides. The ribs 17 and 17 typically abut on both left and right sides of the large link member 15 and the large link member 15 is easily interposed between left and right directions of the key top 13. The wobbling is suppressed in left and right directions of the key top 13 by the abutment.

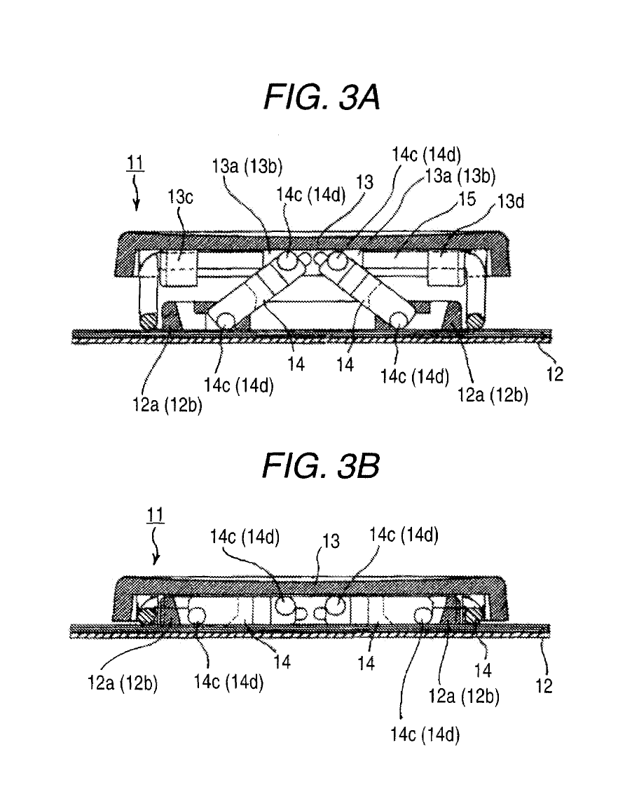

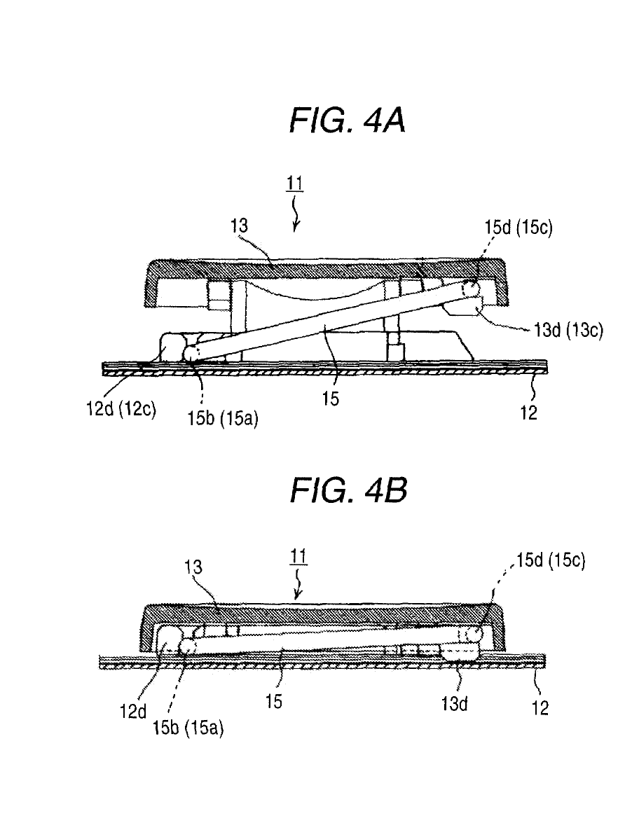

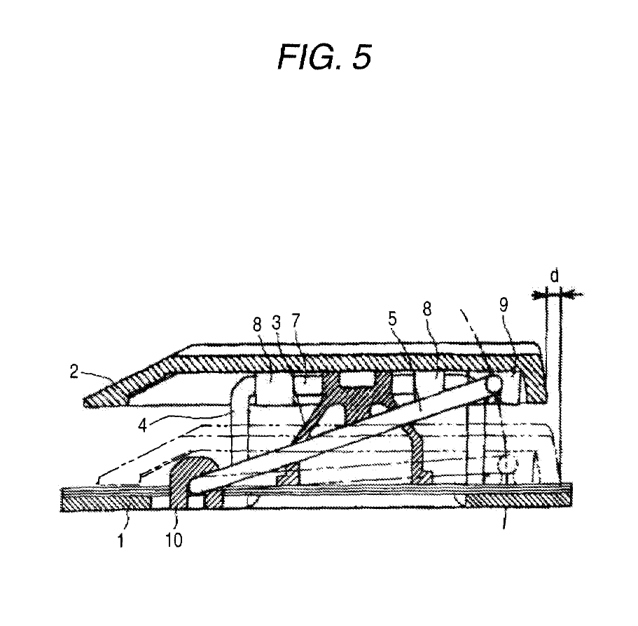

As shown in FIGS. 3A and 4A, before the key top 13 is depressed, the rubber spring 16 described above urges the key top 13 upwardly. Accordingly, the small link member 14 and the large link member 15 are raised at a predetermined angle relative to the board 12.

When the operator depresses the key top 13 in this state, the key top 13 depresses the rubber spring 16 so as to deform it and the small link member 14 and the large link member 15 are depressed down. At this moment, the small link members 14 pivots in directions reversal to each other. That is, the slide portions 14a and 14b at both lower ends of the small link member 14 slide relative to the slide guides 12a and 12b formed in the board 12 along the top surface of the board 12. In addition, the rotary portions 14c and 14d at both upper ends of the small link member 14 rotate inwardly in the bearing portions 13a and 13b with slits on the rear surface of the key top 13. The slide portions 14a and 14b at both lower ends of the other small link member 14 slide in an outer horizontal direction away from the one small link member 14 and the rubber spring 16 in the slide guides 12a and 12b along the top surface of the board 12. The rotary portions 14c and 14d at the upper ends of the small link member 14 rotate inwardly in the bearing portions 13a and 13b with slits on the rear surface of the key top 13c.

Meanwhile, the rotary portions 15a and 15b at the lower ends of the large link member 15 rotate in the bearing portions 12c and 12d with slit provided on the board 12. In addition, the rotary portions 15c and 15d at the upper ends of the large link member 15 slide outwardly in the slide guides 13c and 13d of the key top 13 along the top surface of the board 12.

Due to the linking action of the small link member 14 and the large link member 15, the key top 13 is depressed in the directly vertical direction in a state where the key top 13 is substantially in parallel with the board 12. When the key top 13 is depressed down to a predetermined position, the rubber spring 16 makes a switch member (not shown) provided on the board 12 turn on.

Further, as shown in FIGS. 3B and 4B, when the key top 13 is depressed down to the lowermost point, the bottom surface of the key top 13 bring into contact with the board 12. Accordingly, the key top is not depressed any more.

When the depressing force of the key top 13 is released, the key top 13, the small link members 14 and the large link members 15 are moved by a force of rubber spring 16 in a direction reversal to the direction at the time when depressed. Then, as shown in FIGS. 3A and 4A, the key top 13 returns to a predetermined position and makes the switching member turn off in the middle thereof.

As described above, in the structure of the key switch device according to the embodiment, when the key top 13 is depressed, the upper end portions of the small link member 14 rotate between the key top 13 and the board 12. Simultaneously, the lower end portions of the small link member 14 slide in the slide guides 12a and 12b in the horizontal direction along the top surface of the board 12. Since the small link members 14 are disposed symmetrically, the key top 13 is held by the small link members 14 while receiving an equivalent force from both left and right sides. And the key top 13 can move directly downwards. On the other hand, the rotary portions 15a and 15b which are the lower end portions of the large link member 15 rotate between the board 12 and the key top 13. Simultaneously, the slide portions 15c and 15d which are the upper end portions of the large link member 15 slide relative to the slide guides 13c and 13d in the horizontal direction. And the key top 13 can move directly downwards. Accordingly, the depressed key top 13 can move directly downwards by operations of the small link members 14 and the large link member 15. Therefore, it becomes possible to increase a density by narrowing the gap between the adjacent key tops 13, thereby miniaturizing the entirety of the keyboard.

It becomes possible to improve the operability of the operator by increasing the surface area of the key top 13 as large as the gap even in the space of a same keyboard 13.

It is possible to prevent the wobbling in the sliding direction and the rotation direction of the key top 13 by depressing of the small link members 14 and suppressing by the abutment between the ribs 17 provided on both left and right sides of the key top 13 and the large link member 15. Accordingly, it is possible to smoothly perform a depressing operation of the key top 13 smoothly, thereby improving the touch of the key and obtaining a high-quality operation feeling.

Since a pair of the small link members 14 and the large link member 15 are held in connection with the key top, the force holding the key top 13 increases. Therefore, it is possible to prevent the key top 13 from being improperly removed.

The invention can be modified in a variety of ways without departing from the spirit of the invention, and it is a matter of course that the invention encompasses the modified examples.

What is claimed is:

1. A key switch device, comprising:
a board;
a key top;
a first bearing member provided on the key top;
a second bearing member provided on the key top;
a first guide member provided on the board;
a second guide member provided on the board;
a first link member disposed between the board and the key top, and having a first end portion rotatably supported by the first bearing member and a second end portion engaged with the first guide member;
a second link member disposed between the board and the key top, and having a third end portion rotatably supported by the second bearing member and a fourth end portion engaged with the second guide member; and
a third link member disposed between the board and the key top, wherein:
the first link member, the second link member, and the third link member are not in contact with each other;
the second end portion is slidable relative to the first guide member in a first horizontal direction so that the first end portion is movable in a vertical direction;
the fourth end portion is slidable relative to the second guide member in a second horizontal direction opposite to the first horizontal direction so that the third end portion is movable in the vertical direction; and
the first link member and the second link member are symmetrically arranged.

2. The key switch device as set forth in claim 1, wherein:
the second end portion is slidable in a direction opposite to the second link member in accordance with a movement of the key top member; and
the fourth end portion is slidable in a direction opposite to the first link member in accordance with the movement of the key top member.

3. The key switch device as set forth in claim 1, further comprising:
a third bearing member provided on the board; and
a third guide member provided on the key top, wherein:
the third link member has a fifth end portion rotatably supported by the third bearing member and a sixth end portion engaged with the third guide member; and
the sixth end portion is slidable relative to the third guide member in a third horizontal direction perpendicular to the first horizontal direction and the second horizontal direction so that the fifth end portion is movable in the vertical direction.

4. The key switch device as set forth in claim 3, wherein:
the third bearing member is formed with a hole rotatably supporting the fifth end portion and a slit communicating with the hole so that the fifth end portion is press-fitted into the hole through the slit.

5. The key switch device as set forth in claim 1, further comprising:
a first rib member supporting the third link member in the first horizontal direction; and
a second rib member supporting the third link member in the second horizontal direction, wherein:
the first rib member and the second rib member clamp the third link member.
